(19) United States
(12) Patent Application Publication
(10) Pub. No.: US 2011/0108545 A1
(43) Pub. Date: May 12, 2011

(54) HEATER AND METHOD FOR MAKING THE SAME

(75) Inventors: JIA-PING WANG, Beijing (CN); SHOU-SHAN FAN, Beijing (CN)

(73) Assignees: TSINGHUA UNIVERSITY, Beijing (CN); HON HAI PRECISION INDUSTRY CO., LTD., Tu-Cheng (TW)

(21) Appl. No.: 12/822,231

(22) Filed: Jun. 24, 2010

(30) Foreign Application Priority Data
Nov. 10, 2009 (CN) 200910109712.6

(51) Int. Cl. H05B 3/06; H01C 17/02

(52) U.S. Cl. 219/546; 29/611

(57) ABSTRACT

A heater includes a first electrode, a second electrode, and a heating element. The second electrode is spaced from the first electrode. The heating element includes a first substrate, a second substrate, a first adhesive layer, a second adhesive layer and a carbon nanotube structure. The carbon nanotube structure is located between the first substrate and the second substrate, and combined with the first substrate by the first adhesive layer, and combined with the second substrate by the second adhesive layer. The carbon nanotube structure is electrically connected to the first electrode and the second electrode. A method for making the heater is also provided.

### CROSS-REFERENCE TO RELATED APPLICATIONS

This application claims all benefits accruing under 35 U.S.C. §119 from China Patent Application No. 200910109712.6, filed on Nov. 10, 2009 in the China Intellectual Property Office, disclosure of which is incorporated herein by reference.

### BACKGROUND

1. Technical Field

The present disclosure relates to a heater and a method for making the same.

2. Discussion of Related Art

Conventionally, heaters include a heating element and at least two electrodes. The at least two electrodes are located on a surface of the heating element, and electrically connected to the heating element. The heating element generates heat when a voltage is applied thereto.

The heating element can be made of metals, such as tungsten or carbon fibers. Metals, which have good conductivity, can generate a lot of heat even when a low voltage is applied. However, metals may easily oxidize, thus the heating element has a short life. Furthermore, metals have a relatively high density, and so metal heating elements are heavy, which limits their application. Additionally, metal heating elements are difficult to bend to desired shapes without breaking.

What needed, therefore, is a heater and a method for making the same in which the above problems are eliminated or at least alleviated.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a heater.

FIG. 2 is a Scanning Electron Microscope (SEM) image of a carbon nanotube film in the heater.

FIG. 3 is a flow chart of an embodiment of a method for making a heater.

Corresponding reference characters indicate corresponding parts throughout the several views. The examples set out herein illustrate at least one embodiment of the present heater and a method for making the same, in at least one form, and such examples are not to be construed as limiting the scope of the disclosure in any manner.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

References will now be made to the drawings to describe, in detail, embodiments of the present heater and a method for making the same.

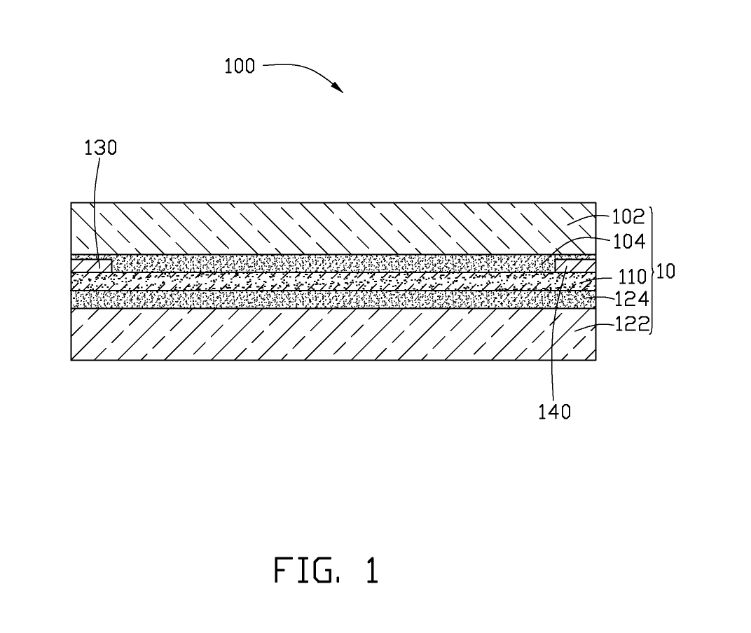

One embodiment of a heater 100 is illustrated in FIG. 1. The heater 100 includes a heating element 10, a first electrode 130, and a second electrode 140. The heating element 10 includes a first substrate 102, a first adhesive layer 104, a second substrate 122, a second adhesive layer 124, and a carbon nanotube structure 110. The carbon nanotube structure 110 is combined with the first substrate 102 by the first adhesive layer 104 and combined with the second substrate 122 by the second adhesive layer 124. The first substrate 102 and the second electrode 140 are located separately and electrically connected to the carbon nanotube structure 110.

A material of the first substrate 102 and the second substrate 122 can be the same or different; and can be made of a flexible material or a rigid material. The first substrate 102 and the second substrate 122 can be used to protect the carbon nanotube structure 110. In one embodiment, the material of the first substrate 102 is a heat insulation material, such as, quartz, diamond, glass or ceramic. The material of the first substrate 102 being a heat insulative material is conducive to increase heat-retaining properties of the heater 100. A material of the second substrate 122 can be heat conductive material, such as metal, to conduct heat produced by the carbon nanotube structure 110 to an object to be heated. The material of the first substrate 102 and the second substrate 122 can be one of polymers, fabrics, metals, quartz, diamond, glass and ceramics. The polymers can be one of polycarbonate (PC), polymethyl methacrylate (PMMA), polyethylene terephthalate (PET) and other polyester materials, and polyether sulfone (PES), cellulose esters, benzocyclobutene (BCB), polyvinyl chloride (PVC) and acrylic resin. The fabrics can be cotton, hemp, fiber, nylon, spandex, polyester, polyacrylonitrile, wool, silk or a mixture of two or more above materials. When at least one of the first substrate 102 and the second substrate 122 is made of conductive material, such as metal, the carbon nanotube structure 110 can be insulated from the first substrate 102 and the second substrate 122. A thickness of the first substrate 102 and of the second substrate 122 can be in a range from about 10 centimeters to about 1 millimeter (mm), and selected according to need.

A thermal response speed of the heater 100 is related to the thickness of the first substrate 102 and of the second substrate 122. The greater the thickness of the first substrate 102 and of the second substrate 122, the slower the thermal response speed of the heater 100, and vice versa. The first substrate 102 and the second substrate 122 can each have a planar structure or a curved structure as required. In one embodiment, the material of the first substrate 102 and that of the second substrate 122 are different. The material of the first substrate 102 is polyethylene terephthalate, and the material of the second substrate 122 is metal.

The carbon nanotube structure 110 can include at least one carbon nanotube film, at least one carbon nanotube wire structure or a combination thereof. Specifically, the carbon nanotube structure 110 can include a carbon nanotube film, a plurality of coplanar carbon nanotube films, or a plurality of stacked carbon nanotube films. The carbon nanotube structure 110 also can include a plurality of carbon nanotube wire structures parallel to each other, crossed with each other, or woven together. The carbon nanotube structure 110 also can include at least one carbon nanotube wire structure located on a surface of the at least one carbon nanotube film. The carbon nanotubes in the carbon nanotube structure 110 can be selected from single-walled, double-walled, and/or multi-walled carbon nanotubes. Diameters of the single-walled carbon nanotubes range from about 0.5 nanometers (nm) to about 50 nm. Diameters of the double-walled carbon nanotubes range from about 1 nm to about 50 nm. Diameters of the multi-walled carbon nanotubes range from about 1.5 nm to about 50 nm.

The carbon nanotube film can be a freestanding film. The carbon nanotube film includes a plurality of carbon nanotubes distributed uniformly and attracted by van der Waals attractive force therebetween. The carbon nanotubes in the carbon nanotube film can be aligned orderly or disorderly. The disorderly aligned carbon nanotubes are the carbon nanotubes being arranged along many different directions, such that the number of carbon nanotubes arranged along each different direction can be almost the same (e.g. uniformly disordered); and/or entangled with each other. The orderly aligned carbon nanotubes are the carbon nanotubes being arranged in a consistently systematic manner, e.g., most of the carbon nanotubes are arranged approximately along a same direction or have two or more sections within each of which the most of the carbon nanotubes are arranged approximately along a same direction (different sections can have different directions). Specifically, the carbon nanotube film can be a drawn carbon nanotube film, a flocculated carbon nanotube film, a pressed carbon nanotube film or a long carbon nanotube film.

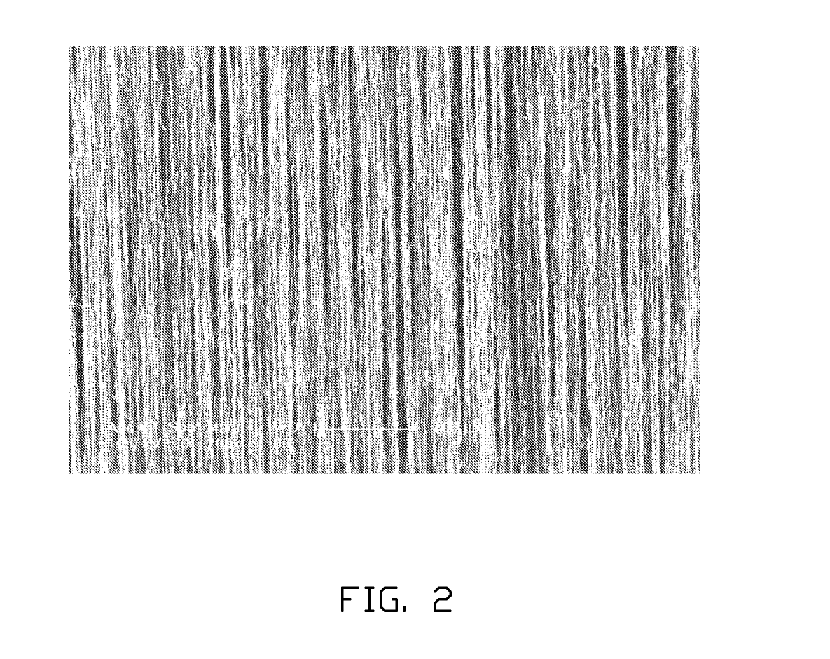

A film can be drawn from a carbon nanotube array, to obtain the drawn carbon nanotube film. Examples of the drawn carbon nanotube film are taught by U.S. Pat. No. 7,045,108 to Jiang et al., and WO 2007015710 to Zhang et al. The drawn carbon nanotube film includes a plurality of carbon nanotubes that are arranged substantially parallel to a surface of the drawn carbon nanotube film. A large number of the carbon nanotubes in the drawn carbon nanotube film can be oriented along a preferred orientation, meaning that a large number of the carbon nanotubes in the drawn carbon nanotube film are arranged substantially along the same direction. An end of one carbon nanotube is joined to another end of an adjacent carbon nanotube arranged substantially along the same direction, by van der Waals attractive force. The drawn carbon nanotube film is capable of forming a freestanding structure. The successive carbon nanotubes joined end to end by van der Waals attractive force realizes the freestanding structure of the drawn carbon nanotube film. An SEM image of the drawn carbon nanotube film is shown in FIG. 2.

Some variations can occur in the orientation of the carbon nanotubes in the drawn carbon nanotube film. Microscopically, the carbon nanotubes oriented substantially along the same direction, but they may not be perfectly aligned in a straight line, and some curved portions may exist.

More specifically, the drawn carbon nanotube film can include a plurality of successively oriented carbon nanotube segments joined end-to-end by van der Waals attractive force therebetween. Each carbon nanotube segment includes a plurality of carbon nanotubes substantially parallel to each other, and joined by van der Waals attractive force therebetween. The carbon nanotube segments can vary in width, thickness, uniformity, and shape. The carbon nanotubes in the drawn carbon nanotube film are also substantially oriented along a preferred orientation. A thickness of the drawn carbon nanotube film can range from about 0.5 nm to about 100 μm. A width of the drawn carbon nanotube film relates to the carbon nanotube array that the drawn carbon nanotube film is drawn from.

The carbon nanotube structure 110 can include at least two stacked drawn carbon nanotube films. An angle between the aligned directions of the carbon nanotubes in the two adjacent carbon nanotube films can range from about 0 degrees to about 90 degrees (0°≦α≦90°). Spaces are defined between two adjacent and side-by-side carbon nanotubes in the drawn carbon nanotube film. When the angle between the aligned directions of the carbon nanotubes in adjacent carbon nanotube films is larger than 0 degrees, the carbon nanotubes define a microporous structure. The carbon nanotube structure 110 in one embodiment employing these films will define a plurality of micropores. A diameter of the micropores can be smaller than 10 μm. Stacking the carbon nanotube films will add to the structural integrity of the carbon nanotube structure 110.

The flocculated carbon nanotube film can include a plurality of long, curved, disordered carbon nanotubes entangled with each other. A length of the carbon nanotubes can be larger than about 10 μm. In one embodiment, the length of the carbon nanotubes is in a range from about 200 μm to about 900 μm. Further, the flocculated carbon nanotube film can be isotropic. Adjacent carbon nanotubes are acted upon by van der Waals attractive force to obtain an entangled structure with micropores defined therein. The flocculated carbon nanotube film is very porous. Sizes of the micropores can be less than 10 μm. In one embodiment, sizes of the micropores are in a range from about 1 nm to about 10 μm. Further, due to the carbon nanotubes in the carbon nanotube structure 110 being entangled with each other, the carbon nanotube structure 110 employing the flocculated carbon nanotube film has excellent durability, and can be fashioned into desired shapes with a low risk to the integrity of the carbon nanotube structure 110. The flocculated carbon nanotube film is freestanding due to the carbon nanotubes being entangled and adhered together by van der Waals attractive force therebetween. The thickness of the flocculated carbon nanotube film can range from about 1 μm to about 1 millimeter. In one embodiment, the thickness of the flocculated carbon nanotube film is about 100 μm.

The pressed carbon nanotube film can be a freestanding carbon nanotube film that is formed by pressing a carbon nanotube array down on the substrate. The carbon nanotubes in the pressed carbon nanotube film are arranged along a same direction or along different directions. The carbon nanotubes in the pressed carbon nanotube film can rest upon each other. Adjacent carbon nanotubes are attracted to each other and are combined by van der Waals attractive force. An angle between a primary alignment direction of the carbon nanotubes and a surface of the pressed carbon nanotube film is about 0 degrees to approximately 15 degrees. The greater the pressure applied, the smaller the angle obtained. When the carbon nanotubes in the pressed carbon nanotube film are arranged along different directions, the carbon nanotube structure 110 can have properties identical in all directions parallel to a surface of the carbon nanotube film. A thickness of the pressed carbon nanotube film ranges from about 0.5 nm to about 1 mm. A length of the carbon nanotubes can be larger than 50 μm. Clearances can exist in the carbon nanotube array, therefore, micropores exist in the pressed carbon nanotube film and defined by the adjacent carbon nanotubes. An Example of pressed carbon nanotube film is taught by US PGPub. 20080299031A1 to Liu et al.

The long carbon nanotube film comprises of one carbon nanotube segment. The carbon nanotube segment includes a plurality of carbon nanotubes arranged along a preferred orientation. The carbon nanotube segment is a carbon nanotube film that comprises one carbon nanotube segment. The carbon nanotube segment includes a plurality of carbon nanotubes arranged along a same direction. The carbon nanotubes in the carbon nanotube segment are substantially parallel to each other, have an almost equal length and are combined side by side via van der Waals attractive force therebetween. At least one carbon nanotube will span the entire length of the carbon nanotube segment in a carbon nanotube film. Thus, one dimension of the carbon nanotube segment is only limited by the length of the carbon nanotubes.

The carbon nanotube structure 110 can further include at least two stacked and/or coplanar carbon nanotube segments. Adjacent carbon nanotube segments can be adhered together by van der Waals attractive force therebetween. An angle between the aligned directions of the carbon nanotubes in adjacent two carbon nanotube segments ranges from about 0 degrees to about 90 degrees. A thickness of a single carbon nanotube segment can range from about 0.5 nm to about 100 μm.

The carbon nanotube wire structure includes at least one carbon nanotube wire. When the carbon nanotube wire structure includes a plurality of carbon nanotube wires, the carbon nanotube wires can be parallel to each other to form a untwisted cable or twisted with each other to form a twisted cable. The untwisted cable and the twisted cable are two kinds of linear shaped carbon nanotube structures.

The carbon nanotube wire can be untwisted or twisted. Treating the drawn carbon nanotube film with a volatile organic solvent can obtain the untwisted carbon nanotube wire. In one embodiment, the organic solvent is applied to soak the entire surface of the drawn carbon nanotube film. During the soaking, adjacent parallel carbon nanotubes in the drawn carbon nanotube film will bundle together, due to the surface tension of the organic solvent as it volatilizes, and thus, the drawn carbon nanotube film will be shrunk into an untwisted carbon nanotube wire. The untwisted carbon nanotube wire includes a plurality of carbon nanotubes substantially oriented along a same direction (i.e., a direction along the length direction of the untwisted carbon nanotube wire). The carbon nanotubes are parallel to the axis of the untwisted carbon nanotube wire. In one embodiment, the untwisted carbon nanotube wire includes a plurality of successive carbon nanotubes joined end to end by van der Waals attractive force therebetween. Length of the untwisted carbon nanotube wire can be arbitrarily set as desired. A diameter of the untwisted carbon nanotube wire ranges from about 0.5 nm to about 100 μm. An example of the untwisted carbon nanotube wire is taught by US Patent Application Publication US 2007/0166223 to Jiang et al.

The twisted carbon nanotube wire can be obtained by twisting a drawn carbon nanotube film using a mechanical force to turn the two ends of the drawn carbon nanotube film in opposite directions. The twisted carbon nanotube wire includes a plurality of carbon nanotubes helically oriented around an axial direction of the twisted carbon nanotube wire. In one embodiment, the twisted carbon nanotube wire includes a plurality of successive carbon nanotubes joined end to end by van der Waals attractive force therebetween. Length of the carbon nanotube wire can be set as desired. A diameter of the twisted carbon nanotube wire can be from about 0.5 nm to about 100 μm.

In one embodiment, the carbon nanotube structure 110 includes 10 layers of the drawn carbon nanotube films. An angle between the aligned directions of the carbon nanotubes in the two adjacent drawn carbon nanotube films can range from about 0 degrees to about 90 degrees (0°≦α≦90°).

The first adhesive layer 104 and the second adhesive layer 124 are used to combine the carbon nanotube structure 110 with the first substrate 102 and the second substrate 122. The first adhesive layer 104 and the second adhesive layer 124 can be combined with the carbon nanotube structure 110 at contact portions therebetween or the first adhesive layer 104 and the second adhesive layer 124 can partly penetrate into the carbon nanotube structure 110, resulting in a firmer combination thereof.

The first adhesive layer 104 and the second adhesive layer 124 can be made of low melting-point materials. Specifically, the first adhesive layer 104 and the second adhesive layer 124 can comprise a hot melt glue or other adhesive. The adhesive can have a good compatibility with both the carbon nanotube structure 110 and the first substrate 102 or the second substrate 122. The first adhesive layer 104 and the second adhesive layer 124 can be made of ethylene-vinyl acetate copolymer (EVA, polyethylene vinyl acetate), polyethylene, polyamide, polyester and ethylene-ethyl acrylate, and so on. The first adhesive layer 104 and the second adhesive layer 124 can be made of hot melt glue powders or a hot melt glue film. When the first adhesive layer 104 and the second adhesive layer 124 are made of a hot melt glue film, the first adhesive layer 104 and the second adhesive layer 124 can be formed by directly placing the hot melt glue film on a surface of the first substrate 102 and the second substrate 122. Then, the carbon nanotube structure 110 can be sandwiched between the first adhesive layer 104 and the second adhesive layer 12. The hot melt glue films can form the first adhesive layer 104 and the second adhesive layer 124 after a hot-pressing process. When the first adhesive layer 104 and the second adhesive layer 124 are made of hot melt glue powders, a layer of the hot melt glue powders can be spread on a surface of the first substrate 102; then the carbon nanotube structure 110 is placed on the surface of the first substrate 102 having the hot melt glue powders thereon; after that, another layer of the hot melt glue powders can be spread on a surface of the carbon nanotube structure 110 away from the first substrate 102; and the second substrate 122 is then placed on the surface of the carbon nanotube structure 110 to form a five-layer stacked structure; and finally, the five-layer stacked structure is hot-pressed to form the first adhesive layer 104 and the second adhesive layer 124, thereby forming the heater 100. In one embodiment, both the first adhesive layer 104 and the second adhesive layer 124 are EVA hot melt glue films. The EVA hot melt glue films can be directly placed on the surfaces of the first substrate 102 and the second substrate 122 to form the first adhesive layer 104 and the second adhesive layer 124 after the hot-pressing process.

The first electrode 130 and the second electrode 140 can be located on a surface of the carbon nanotube structure 110 or on two ends of the carbon nanotube structure 110. The first electrode 130 and the second electrode 140 are made of conductive materials. A structure of the first electrode 130 or the second electrode 140 is not limited and can be lamellar, wire, ribbon, block or other structure. A material of the first electrode 130 or the second electrode 140 can be chosen from a group that includes metal, alloy, indium tin oxide (ITO), antimony tin oxide (ATO), conductive silver glue, conductive polymer, conductive carbon nanotubes, and so on. A material of the metal or alloy includes aluminum, copper, tungsten, molybdenum, gold, titanium, neodymium, palladium, cesium, silver, or any combination thereof. In one embodiment, the first electrode 130 and the second electrode 140 are silver ribbons, and located on the surface of the carbon nanotube structure 110. The first electrode 130 and the second electrode 140 are separately located to avoid short-circuiting. A melting point of the first electrode 130 and the second electrode 140 can be greater than a working temperature of the heater 100. The location of the first electrode 130 and the second electrode 140 is related to the arranged direction of the carbon nanotubes in the carbon nanotube structure 110. In one embodiment, the carbon nanotubes in the carbon nanotube structure 110 can be arranged primarily along a direction extending from the first electrode 130 to the second electrode 140.

In other embodiments, a conductive adhesive layer (not shown) can be further provided between the first electrode 130 or the second electrode 140 and the carbon nanotube structure 110. The conductive adhesive layer can be used to provide electrical contact and more adhesion between the electrodes 130, 140 and the carbon nanotube structure 110. In one embodiment, the conductive adhesive layer is a layer of silver paste.

Further, an infrared-reflective layer (not shown) can be located between the first substrate 102 and the first adhesive layer 104. The infrared-reflective layer is configured for reflecting the heat emitted by carbon nanotube structure 110, and controlling the direction of heat from the carbon nanotube structure 110 for single-side heating. The efficiency for heating objects can be increased. The infrared-reflective layer can be made of insulative materials. The material of the infrared-reflective layer can be a white insulative material, and can be selected from one of metal oxides, metal salts, and ceramics. In one embodiment, the infrared-reflective layer is an aluminum oxide (Al₂O₃) film. A thickness of the infrared-reflective layer can be in a range from about 100 μm to about 0.5 mm. The infrared-reflective layer also can be located on the surface of the first substrate 102 away from the carbon nanotube structure 110, that is, the first substrate 102 is located between the infrared-reflective layer and the carbon nanotube structure 110. The infrared-reflective layer is optional.

In use, when a voltage is applied to the first electrode 130 and the second electrode 140, the carbon nanotube structure 110 of the heater 100 radiates heat at a certain electromagnetic wavelength. An object to be heated can be directly attached on or positioned near the heater 100. The heater 100 need not be adhered to object to be heated since the heater 100 has a free-standing structure.

The carbon nanotube structure 110 has excellent electrical conductivity, thermal stability, and high thermal radiation efficiency, because the carbon nanotubes have an ideal black body structure. Thus, the heater 100 can be safely exposed, while working, to oxidize gases in a typical environment or atmospheric environment. When a voltage ranging from about 10 volts to about 30 volts is applied, the carbon nanotube structure 110 can radiate electromagnetic waves having a long wavelength. The temperature of the heater 100 can range from about 50° C. to about 500° C. As an ideal black body structure, the carbon nanotube structure 110 can radiate heat when it reaches a temperature of about 200° C. to about 450° C. The radiating efficiency is relatively high.

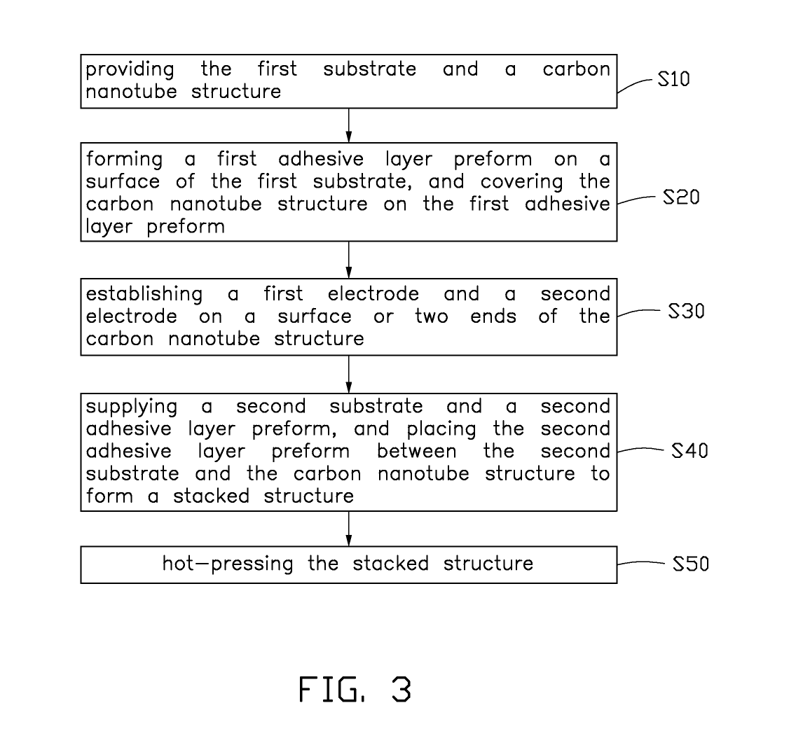

One embodiment of a method for making the heater 100 is illustrated in FIG. 3. The method includes the following steps of:

(S10) providing the first substrate 102 and a carbon nanotube structure 110;

(S20) forming a first adhesive layer preform on a surface of the first substrate 102, and covering the carbon nanotube structure 110 on the first adhesive layer preform;

(S30) establishing a first electrode 130 and a second electrode 140 on a surface or two ends of the carbon nanotube structure 110;

(S40) supplying a second substrate 122 and a second adhesive layer preform, and placing the second adhesive layer preform between the second substrate 122 and the carbon nanotube structure 110 to form a stacked structure; and

(S50) hot-pressing the stacked structure.

In step (S10), when the first adhesive layer preform is made of a hot melt glue film, the hot melt glue film can be placed directly on the surface of the first substrate 102 to from the first adhesive layer preform. When the first adhesive layer preform is made of hot melt glue powders, a layer of the hot melt glue powders can be spread on a surface of the first substrate 102 to form the first adhesive layer preform. In one embodiment, the first adhesive layer preform is an EVA film, and the EVA film can be placed directly on the surface of the first substrate 102 to form the first adhesive layer preform.

The infrared-reflective layer can be formed between the first substrate 102 and the first adhesive layer preform or on the surface of the first substrate 102 away from the first adhesive layer preform. The infrared-reflective layer is optional.

In step (S20), the carbon nanotube structure 110 includes at least one carbon nanotube film, at least one carbon nanotube wire structure, or a combination thereof. In one embodiment, the carbon nanotube structure 110 consists of 10 layers of the drawn carbon nanotube films. The drawn carbon nanotube film can be drawn from a carbon nanotube array, and includes the steps of: (S201) selecting one or more carbon nanotubes having a predetermined width from an array that is able to have carbon nanotubes drawn therefrom; and (S202) pulling the carbon nanotubes to form carbon nanotube segments that are joined end to end at an uniform speed to achieve a uniform drawn carbon nanotube film.

In step (S201), the carbon nanotube segments having a predetermined width can be selected by using a tool such as an adhesive tape, a tweezers, or a clamp to contact the super-aligned array.

In step (S202), the pulling direction is substantially perpendicular to the growing direction of the super-aligned array of carbon nanotubes. Each carbon nanotube segment includes a plurality of carbon nanotubes parallel to each other.

More specifically, during the pulling process, as the initial carbon nanotube segments are drawn out, other carbon nanotube segments are also drawn out end to end due to van der Waals attractive force between ends of adjacent segments. This process of drawing ensures a substantially continuous and uniform drawn carbon nanotube film having a predetermined width can be formed. The drawn carbon nanotube film includes a plurality of carbon nanotubes joined ends to ends. The carbon nanotubes in the drawn carbon nanotube film are all substantially parallel to the pulling/drawing direction of the drawn carbon nanotube film, and the drawn carbon nanotube film produced in such manner can be selectively formed to have a predetermined width. The drawn carbon nanotube film formed by the pulling/drawing method has superior uniformity of thickness and conductivity over a typical disordered drawn carbon nanotube film. Further, the pulling/drawing method is simple, fast, and suitable for industrial applications.

The width of the drawn carbon nanotube film depends on a size of the carbon nanotube array. The length of the drawn carbon nanotube film can be arbitrarily set, as desired. In one embodiment, when the substrate is a 4-inch P-type silicon wafer as in the present embodiment, the width of the drawn carbon nanotube film is in a range from about 0.5 nanometers to about 10 centimeters, and the thickness of the drawn carbon nanotube film is in an approximate range from 0.5 nanometers to 100 microns.

A plurality of the drawn carbon nanotube films can be placed on the first adhesive layer preform to form the carbon nanotube structure 110. The carbon nanotubes in the carbon nanotube structure 110 can be substantially arranged along a same direction or along different directions. When the carbon nanotube structure 110 includes the pressed carbon nanotube film, the flocculated carbon nanotube film, the long carbon nanotube film or the carbon nanotube wire structure, the pressed carbon nanotube film, the flocculated carbon nanotube film, the long carbon nanotube film or the carbon nanotube wire structure also can be directly placed on the surface of the first adhesive layer preform to form the carbon nanotube structure 110.

In one embodiment, 10 layers of the drawn carbon nanotube film are placed on the surface of the first adhesive layer preform to form the carbon nanotube structure 110.

In step (S30), the first electrode 130 and the second electrode 140 are electrically connected to the carbon nanotube structure 110. In one embodiment, both the first electrode 130 and the second electrode 140 are silver ribbons, the silver ribbons are formed on the surface or at two ends of the carbon nanotube structure 110 by a coating method, a screen printing method, or a deposition method. In another embodiment, both the first electrode 130 and the second electrode 140 are formed by a PVD method, such as sputtering.

In step (S40), when the second adhesive layer preform is made of a hot melt glue film, the hot melt glue film can be placed directly on the surface of the second substrate 122 to form the second adhesive layer preform. When the second adhesive layer preform is made of hot melt glue powders, a layer of the hot melt glue powders can be spread on a surface of the second substrate 122 to form the second adhesive layer preform. In one embodiment, the second adhesive layer preform is a EVA film, and the EVA film can be placed directly on the surface of the second substrate 122 to form the second adhesive layer preform. The second substrate 122 with the second adhesive layer preform thereon can cover the surface of the carbon nanotube structure 110.

Step (S50) can be executed in a hot-press device (not shown). The hot-press device can include an upper board and a bottom board. A heating element can be located in the upper board and/or the bottom board. One of the upper board and the bottom board can be larger than or substantially equal to the size of the other of the upper board and the bottom board. In one embodiment, the upper board and the bottom board can have flat surfaces and be parallel to each other. Each of the upper board and the bottom board has a heating element. The above stacked structure can be located between the upper board and the bottom board. Specifically, the bottom board can be fixed, a pressure can be applied by the upper board to the stacked structure. The stacked structure can be placed on the bottom board, and contact with the upper board or is spaced from the upper board. The stacked structure is heated by the heating elements in the upper board and the bottom board to a certain temperature which can be higher than the melting point of the hot melt glue, then a certain pressure is applied by the upper board to the stacked structure. The hot melt glue is melted and flows, and wets and/or is filled into the carbon nanotube structure 110. The pressure applied to the stacked structure is conducive to increasing the fluidity of the hot melt glue, thereby making the composite of the hot melt glue and the carbon nanotube structure 110 easier. The heater 100 is formed after the stacked structure is cured.

At least part of the first adhesive layer 104 and the second adhesive layer 124 are infiltrated into the carbon nanotube structure 110 to form a composite. The amount of the carbon nanotube structure 110 combined with the first adhesive layer 104 and the second adhesive layer 124 is related to the amount of the first adhesive layer 104 and the second adhesive layer 124 in the heater 100. The greater the mass ratio of the first adhesive layer 104 and the second adhesive layer 124 in the heater 100, the greater the amount of the carbon nanotube structure 110 combined with the first adhesive layer 104 and the second adhesive layer 124, and vice versa. Further, the amount of the carbon nanotube structure 110 combined with the first adhesive layer 104 and the second adhesive layer 124 is also related to the thickness of the carbon nanotube structure 110. At a certain mass ratio of the first adhesive layer 104 and the second adhesive layer 124 in the heater 100, the greater the thickness of the carbon nanotube structure 110, the smaller the amount of the carbon nanotube structure 110 combined with the first adhesive layer 104 and the second adhesive layer 124, and vice versa.

The temperature for heating the stacked structure is related to the kind of hot melt glue applied. The pressure applied to the stacked structure can be smaller than 100 MPa. In one embodiment, the temperature for heating the stacked structure is higher than 80° C., and the pressure applied to the stacked structure is 30 MPa. In another embodiment, the temperature for heating the stacked structure is in a range from about 100° C. to about 180° C. In another embodiment, a voltage can be supplied between the first electrode 130 and the second electrode 140 to heat the stacked structure using the carbon nanotube structure 110.

The heater and the method for making the same have merits. Firstly, since the carbon nanotubes have good strength and toughness, the carbon nanotube structure consisting of the carbon nanotubes has a good strength and toughness. Thereby it increases the durability of the heater. Secondly, since the carbon nanotubes are an ideal black body structure, the carbon nanotube structure has good conductivity and thermal stability, and a relatively high efficiency of heat radiation. Thus, the heater adopting the carbon nanotube structure has high electric-thermal conversion efficiency. Thirdly, the material of the first substrate and the second substrate can be the same or different, the first substrate and the second substrate can be made of a variety of materials. Fourthly, when the first substrate is made of an insulative material and the second substrate is made of a thermal conductive material, the heater has a good heating property at the side of the second substrate. The first substrate can have a good heat-retaining property; thereby it is conducive to increase the heating property of the heater.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A heater, comprising:
a first electrode;
a second electrode spaced from the first electrode;
a heating element, the heating element comprising:
a first substrate;
a second substrate;
a first adhesive layer;
a second adhesive layer; and
a carbon nanotube structure,
wherein the carbon nanotube structure is located between the first substrate and the second substrate, combined with the first substrate by the first adhesive layer, and combined with the second substrate by the second adhesive layer; and the carbon nanotube structure is electrically connected to the first electrode and the second electrode.

2. The heater of claim 1, wherein the carbon nanotube structure comprises at least one carbon nanotube film, at least one carbon nanotube wire structure, or a combination thereof.

3. The heater of claim 2, wherein the at least one carbon nanotube film comprises a plurality of carbon nanotubes distributed uniformly therein.

4. The heater of claim 2, wherein the carbon nanotube structure comprises two or more stacked, coplanar carbon nanotube films, or combinations thereof.

5. The heater of claim 4, wherein the at least one carbon nanotube film comprises a plurality of carbon nanotubes substantially parallel to a surface of the at least one carbon nanotube film, the plurality of the carbon nanotubes are joined end-to-end by van der Waals attractive force therebetween and substantially aligned along a same direction.

6. The heater of claim 2, wherein the carbon nanotube structure comprises a plurality of carbon nanotube wire structures parallel to each other, crossed with each other, woven together, or a combination thereof.

7. The heater of claim 2, wherein the at least one carbon nanotube wire structure comprises at least one twisted carbon nanotube wire, at least one untwisted carbon nanotube wire, or a combination thereof.

8. The heater of claim 7, wherein the at least one carbon nanotube wire structure is a untwisted cable or a twisted cable.

9. The heater of claim 1, wherein the carbon nanotube structure comprises at least one carbon nanotube wire structure and at least one carbon nanotube film, the at least one carbon nanotube wire structure is located on a surface of the at least one carbon nanotube film.

10. The heater of claim 1, wherein a material of the first adhesive layer and the second adhesive layer is hot melt glue.

11. The heater of claim 10, wherein at least part of the first adhesive layer and the second adhesive layer infiltrate the carbon nanotube structure.

12. The heater of claim 10, wherein a material of the hot melt glue comprises a material that is selected from the group consisting of ethylene-vinyl acetate copolymer, polyethylene, polyamide, polyester and ethylene-ethyl acrylate.

13. The heater of claim 1, wherein a material of the first substrate and the second substrate comprises a material that is selected from the group consisting of polymers, fabrics, metals, quartz, diamond, glass and ceramics.

14. The heater of claim 1, further comprising an infrared-reflective layer located between the first substrate and the first adhesive layer or on a surface of the first substrate away from the carbon nanotube structure.

15. The heater of claim 14, wherein a material of the infrared-reflective layer is selected from the group consisting of metal oxides, metal salts, and ceramics.

16. A method for making a heater, the method comprising:
(S10) providing a first substrate and a carbon nanotube structure;
(S20) forming a first adhesive layer preform on a surface of the first substrate, and covering the carbon nanotube structure on the first adhesive layer preform;
(S30) establishing a first electrode and a second electrode on a surface of or two ends of the carbon nanotube structure;
(S40) supplying a second substrate and a second adhesive layer preform, placing the second adhesive layer preform between the second substrate and the carbon nanotube structure to form a stacked structure; and
(S50) hot-pressing the stacked structure.

17. The method of claim 16, wherein a material of the first adhesive layer preform and the second adhesive layer preform is hot melt glue.

18. The method of claim 17, wherein step (S50) comprises a substep of heating the stacked structure to a temperature higher than a melting point of the hot melt glue.

19. The method of claim 16, wherein step (S50) further comprises a substep of applying a pressure to the stacked structure, wherein the pressure is less than 100 MPa.

20. The method of claim 16, wherein the carbon nanotube structure comprises at least one carbon nanotube film, the at least one carbon nanotube film comprises a plurality of carbon nanotubes substantially parallel to a surface of the at least one carbon nanotube film, the plurality of the carbon nanotubes are joined end-to-end by van der Waals attractive force therebetween and substantially aligned along a same direction.
